(19) United States
(12) Patent Application Publication
(10) Pub. No.: US 2018/0234367 A1
(43) Pub. Date: Aug. 16, 2018

(54) USER TRANSITION FROM MESSAGING INTERFACE TO WEB-BASED INTERFACE

(71) Applicant: Marketing Architects, Inc., Minneapolis, MN (US)

(72) Inventors: Aaron Lange, Eden Prairie, MN (US); Jeffrey C. Clement, Maple Grove, MN (US); Kirk Leand, Minneapolis, MN (US); Jon Kerr, Eagan, MN (US); Jeffrey Clark, Minnetrista, MN (US)

(21) Appl. No.: 15/894,515

(22) Filed: Feb. 12, 2018

Related U.S. Application Data
(60) Provisional application No. 62/458,152, filed on Feb. 13, 2017.

(51) Int. Cl. H04L 12/58; G06F 17/30; H04L 29/08; G06F 3/0483; H04W 4/14

(52) U.S. Cl. CPC H04L 51/08; G06F 17/3089; G06F 17/30887; H04L 67/306; G06F 3/0483; H04L 51/10; H04W 4/14; H04L 67/02

(57) ABSTRACT

A user of a phone can initiate a communication session by sending a text message (e.g., a Short Message Service (SMS) or Search Results Multimedia Messaging Service (MMS) message) to a predetermined phone number. In response, a reply message may be sent back, and the reply message can include a link that, when followed, navigates the phones web browser to a web-based chat interface to, for example, guide the user through a series of questions or collect information from the user to complete a transaction. In this way, an intuitive, coherent chat experience can be provided to the user, even if restrictions on text messaging are in place.

### CLAIM OF PRIORITY

This application claims priority U.S. Provisional Application Ser. No. 62/458,152, filed on Feb. 13, 2017, the entire contents of which are hereby incorporated by reference.

### TECHNICAL FIELD

The present document relates to computer communications via a messaging interface (e.g., such as SMS text messages) and a web-based interface (such as chat session conducted on one or more webpages).

### BACKGROUND

Computers are devices that can be instructed to carry out sets of arithmetic or logical operations. Many computers use hardware configured to follow a sequence of operations, often called a program. Most programs receive input data, process the data, and provide output data. Computers are able to communicate with each other via computer networks. Computer networks include hardware elements and software elements to transfer messages in mutually understood formats. Many computers are able to communicate via more than one computer network.

In some examples, users of a smartphone or other types of mobile phones can communicate with a computer system/service provider via text messaging sessions. For instance, a service provide can invite users to initiate communications via a 5-digit SMS short code that provides a convenient manner of contacting the service provider. Short codes are often implemented for value-added services such as charity donations, mobile services, ordering predetermined products, and the like.

### SUMMARY

Some embodiments of systems and methods described herein are configured for a user of a mobile phone to initiate a communication session by sending a text message (e.g., a Short Message Service (SMS) or Search Results Multimedia Messaging Service (MMS) message) to a predetermined recipient number (e.g., a 5-digit SMS short code, a 10-digit telephone number, or another alpha-numeric code for initiating a text messaging session). In response, a reply message may be sent back, and the reply message can include a hyperlink that, when executed by the user within the interface of the text messaging session, navigates the mobile phone's web browser to a web-based chat interface to, for example, continue the previously initiated communication session and optionally guide the user through a series of questions or collect information from the user to complete a transaction. As such, some implementations described herein provide an intuitive, coherent chat experience can be provided to the user while contemporaneously avoiding or otherwise bypassing restrictions of the originally initiated text messaging interface that might otherwise limit/impinge upon the reply messages or other aspects of the overall communication session.

Particular implementations described herein can optionally achieve some or all of the following advantages. First, in response to hearing and/or viewing an invitation from a service provider or another advertisement, a user utilizes an internet-connected device to initiate a text messaging session (e.g., by sending a text message to an SMS short code address, or the like), and the system is configured to transition the initiated text messaging session into communication session via web-chat system (e.g., in some cases, for purposes of a lead generation or to complete a purchase of a good or service via the web-chat system). The web-chat system can be loaded from a link via a text/email/social media/other, embedded on a webpage, and/or loaded directly from a web browser. Optionally, the user is automatically greeted upon loading of the web-chat system. The system can be configured to guide the user through a chat-like experience driven from a web-chat system, which can optionally be algorithm sourced by scripted content.

Second, some embodiments of the system described herein can be configured to provide user interaction with the web-chat system that replicates some or all aspects of the originally initiated interface of the text messaging session, for example, with typing delays between responses and text enclosed in text “bubbles.”

Third, some embodiments of the web-chat system user experience also include a section that allows the dynamic delivery of supporting visual/audio directly related to script elements and/or to responses by user, thereby enhancing the user interface beyond the originally initiated interface of the text messaging session (in some cases). The web-chat system user experience can be matched to original advertisement including but not limited to branding, offer details, voice, scripting, and/or visual cues.

Fourth, some embodiments described here can advantageously record data collected from user and show such recorded data back to the user during the communication session via the web-chat system.

Fifth, some embodiments of the web-chat system can utilize the user's phone to link directly to a live agent, or offer opt in to text conversation to send user product information or order confirmation. The web-chat system can optionally deliver dialog direct from a live agent (both audio and video), It can also collect user inputs while connected to a live agent. When applicable, web-chat system algorithm can be replaced with a live agent who can take over the conversation with user and supplement or conclude transaction.

Sixth, in some optional embodiments, the web-chat system can directly collect from user all info needed to purchase a product or prompt user to approve a link to digital payment systems as part of check out. The web-chat system can provide users the ability to call an IVR system to collect key purchase information. The web-chat system algorithm used can collect key words from user during engagement and provide specific product details. The web-chat system algorithm used can collect and capture key words from user during engagement for future analytics and learnings about user behaviors. These key words and behaviors can be reviewed and sourced for future context for the algorithm to use. In some implementations, the web-chat system algorithm can dynamically gather new unique inputs for lead generation or purchase based on responses.

Seventh, some embodiments of the web-chat system algorithm can capture and store each user interaction based on script position and points of data entry. Optionally, the web-chat system algorithm can be updated real time. Also, in particular implementations, the web-chat system algorithm can be configured to conduct A/B/n testing, can be updated via an admin UI allowing clients to review/update algorithm inputs and view campaign results real time, can be updated from multiple external sources including being integrated to our proprietary VOCE IVR platform, or a combination thereof. Optionally, the web-chat system admin UI displays a visual representation of the web-chat system algorithm's output real time for consistent testing and easier ability to update script flows and new data input entries. Each user interaction in the web-chat system is a chat module that can be created, tested, and deployed as a separate module of code and can then be incorporated into existing and/or new campaign scripts. In some implementations, the web-chat system can connect directly to a 3rd party API for real time direct lead and/or order creation.

Eighth, some embodiments of the web-chat system can access a user's camera and use artificial intelligence software (face detection, emotion detection) to identify the user's gender, age and emotional state. Based on this information, the system is able to provide customized scripts and chat experience.

Ninth, some embodiments of the web-chat system can use Short Message Service (SMS) and/or Search Results Multimedia Messaging Service (MMS) message), wherein the text message is sent from a short code number.

Tenth, some embodiments of the web-chat system can use a website that is configured to be rendered on the user device, and wherein the website, when rendered provides the user with a chat experience that includes providing the user with text communications and provides the user with input elements to receive the submitted chat input.

Eleventh, some embodiments of the web-chat system can use a script defines a decision tree that, when used by the rendered webpage, provides text communication defendant upon the received chat input.

Twelfth, some embodiments of the web-chat system can use a chat server that is further configured to receive, from a second user device, a second request for the website, the request from the second user device being generated based on a link rendered in a different website

Thirteenth, some embodiments of the web-chat system can use a chat server that is further configured to generate a new account in an external service for a user of the user device based on the chat input.

Fourteenth, some embodiments of the web-chat system can use a chat server that is further configured to schedule an appointment for a user of the user device based on the chat input.

Fifteenth, some embodiments of the web-chat system can use a chat server that is further configured to transmit a transaction record to an external service based on the chat input.

Sixteenth, some embodiments of the web-chat system can use a chat server that is further configured to collect experience metrics based on the chat input; collect external data from an external system based on the chat input; calculate, for a user of the user device, a priority value; and transmit, to a second external system, the priority value.

Seventeenth, some embodiments of the web-chat system can use a priority value that is a sales-lead priority value.

Eighteenth, some embodiments of the web-chat system can

### DESCRIPTION OF DRAWINGS

FIG. 1 is a schematic diagram of a system in which a phone communicates via SMS and webpage.

FIG. 2 is a user interface of a phone showing a SMS conversation.

FIGS. 3-8 are user interfaces of a phone showing a webpage based conversation.

FIG. 9 is a flowchart of an example process for communicating over SMS and webpage.

FIG. 10 is a schematic diagram that shows an example of a computing device and a mobile computing device.

FIG. 11 is a flowchart of an example process for serving a webpage that provides a chat interface.

Like reference symbols in the various drawings indicate like elements

### DETAILED DESCRIPTION

This document describes technology that may be used to enable back-and-forth text chatting in situations where an originally initiated text message protocol restricts the amount of/type of back-and-forth communications due to technological or rules-based limitations. For example, in some areas, SMS and MMS messages may be addressed to short-code telephone numbers. These short codes may be available, but only to parties who agree not to send more than one reply text message for each message received. Additionally or alternatively, each text message may incur a fee, and reducing or eliminating text message fees may reduce the cost of the back-and-forth text chatting.

The system can provide a user with a coherent chat experience, an SMS or MMS message can be responded to with a reply message that contains a hyperlink to a webpage or the like (e.g., a platform outside of the originally initiated interface of the text messaging session). The webpage, when loaded by the user via execution on the hyperlink embedded in the originally initiated interface of the text messaging session, can transition the user to another interface that allows the user to chat with a human or automated-response script. In this way, users who are interested in having a chat communication, as indicated by their use of a text message, can be provided with a chat communication in a web-based platform without the restrictions or text-messaging fees of the originally initiated text messaging session and without having to, for example, remember and type a webpage address into a web browser application.

This can enable various user experiences. For example, a marketer driven experience is on in which a marketer designs a chat interaction to move toward a particular resolution selected by the marketer. In the case of a user making contact with a broken electronic device, the marketer driven experience may be designed to move the user to a work-around for their problem, or to open a ticket to have their issue addressed by an expert. In the case of lead generation, the marketer driven experience may be designed to collect information from a user interested in a product so that the vendor of the product can make them a beneficial offer.

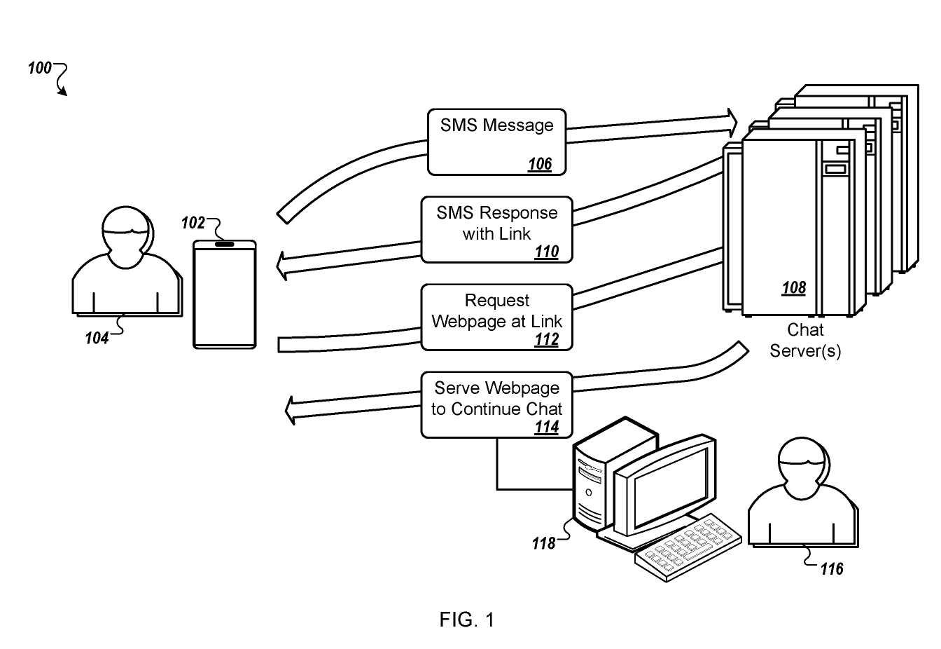

FIG. 1 is a schematic diagram of a system 100 in which a phone 102 (e.g., a smartphone or other mobile communication device) communicates via SMS and (optionally) via a web-based platform such as webpage providing a web-chat interface. In the system 100, a user 104 is using the phone 102. The phone 102 may be, for example, a smart phone capable of executing chat and web browser applications. In other examples, the phone 102 could be replaced with another computing device capable of executing chat and web browser applications (e.g., a laptop, a tablet).

The user 104 learns of a chat-communication opportunity that they are interested in. For example, the user 104 may view a television clip or read a magazine article that offers to provide the user with more information if they send a particular text message to a particular address. This may be, for example, a particular word sent by SMS to a particular short code. For example, the user may be reading a news magazine that offers to sell the user a subscription if they text the word “subscribe” to a particular phone number. In another example, the user may be reading a news magazine that offers to provide the user supplementary information if they text the phrase “tell me more” to a particular phone number.

The user 104 can then use the appropriate chat program on the phone 102 to compose and send a text message as indicated. In this example, the user 104 uses the phone 102 to send a SMS message 106 to the short code. The SMS message 106 is then routed to the appropriate recipient, a chat server 108. The chat server 108 may include processes that are configured to listen for these kinds of SMS messages and to respond to them according to, for example, a script or template stored by the chat server 108. The chat server 108 may be a single hardware device, but other configurations are possible. For example, the chat server may include multiple hardware devices that are geographically separated, may include one or more virtual machines located on different hardware, or may include processes run on a cloud service provider that abstracts away the hardware implemented to run the chat server 108.

When the chat server 108 receives the SMS message 106, the chat server can generate or call up a SMS response 110. The SMS response 110 can include a link to a webpage so that, when the SMS response 110 is rendered on the phone 102, the link is rendered as a web link that the user 104 can follow by, for example, tapping on the link.

If the user 104 does choose to tap on the link or otherwise follow it, the phone 102 can execute a web browser on the phone 102 and generate a request 112 that requests the webpage that is specified by the link. For example, if the SMS response 110 includes a link to a location at “http://example.com/4CHAT,” a web browser application on the phone 102 can send the request 112 for the webpage that is hosted at “http://example.com/4CHAT.”

The request 112 can be routed to its destination, in this case the chat server 108. As previously described, the chat server 108 may take the form of one or more hardware devices. In some situations, the request 112 is routed to the same hardware device as the SMS message 106 is sent to. In some situations, the request 112 is routed to a different hardware device than the SMS message 106 is sent to. The chat server 108 can respond to the request 112 by serving a webpage 114 that has an interface for continuing the chat experience that began with the SMS message 106. For example, the webpage 114 may be configured so that it displays, on the phone 102, a user interface that includes chat-elements such as an input field, a submit button, and a dynamically updating, reverse-chronological list of recent chat messages.

The webpage 114 may be configured to respond to chat input from the user 104 according with automated or human-directed chat. For example, the webpage 114 may be configured to request information from the user 104. This information may be collected, for example, to help guide the user 104 to some personalized information or product, to collect payment information, or to identify a situation in which a human user should take over from the automated portion of the chat.

In order to provide the user with a chat experience, the chat server 108 may access one or more scripts created by a user. This script may define the chat experience provided to the user 104. For example, the script may include the words of the chat, as well as information about how those words should be presented. This presentation data in the script can include, but is not limited to, speed and timing metadata that defines the speed and timing of new messages to the user 104, appearance metadata that defines the appearance of the chat, including font presentations, colors in the user interface, image metadata that defines images to be displayed, etc.

This script may be created by a user using an interface that requires little or no special technical expertise. That is, the script generating interface may require only human-readable language input not computer-language or computer-coding input. This can advantageously allow for the generation of a script by a user that is a subject matter expert about a particular product or service, but who is not an expert at computer programming.

For example, a user 116 may be made available to participate in chat conversations via a computer 118. This user 116 may be, for example, a salesperson, an account specialist, a technical support assistant or the like, that has been tasked with participating in chats that cannot be successfully completed using only automated scripts.

In the example described above, in which the user 102 can purchase a subscription to the news magazine, the user may have an unexpected question that an automated script isn't able to handle (e.g., “what happened to that one writer that you used to publish?” or “Would this be a good magazine for child interested in bugs?”). In the example in which a user requests more information, the user 116 may be available to help the user 104 identify what kind of supplemental information they are interested in. In such cases, the user 116 may enter the chat provided by the webpage 114 to replace or to augment the script.

In some cases, text-to-speech or other audio technology may be used to enhance the chat experience. For example, text-to-speech or a recorded human voice can be used to recite the messages of the chat for the user 104. Additionally, or alternatively, the audio may differ from the text or images of messages. For example, a narrator may describe some of the benefits of a product while a short video or animated image (e.g., an animated .gif) shows a rotating 360 view of a product. This audio enhancement may be useful to aid a user 104 that has language or reading difficulties (e.g. one for whom the chat is in a second language), to aid in a user 104 that wishes to look away from the screen (e.g., to find a credit card, to walk or exercise while chatting), or who prefers to consume information via audio instead of text. By using a webpage instead of a native chat program, this audio enhancement can be provided with more flexibility than would be possible in the native chat program.

As described, this chat experience may be organized into a decision tree format. This decision tree may be created, for example as part of the script used to define the chat experience. For example, the script may describe one or more questions that, depending on the user's 104 answer, lead to different questions. For example, a script may ask the user 104 if they have ever purchased a product from the vendor that is being advertised. If the user indicated they have purchased before, the script may follow a “returning customer” path in which the customer is asked for the log in credentials, asked about their satisfaction with the previous purchase, etc. If the user indicates they have not purchased before, the script may follow a “new customer” path in which the customer is asked for their contact information or asked if they would like to create a user account.

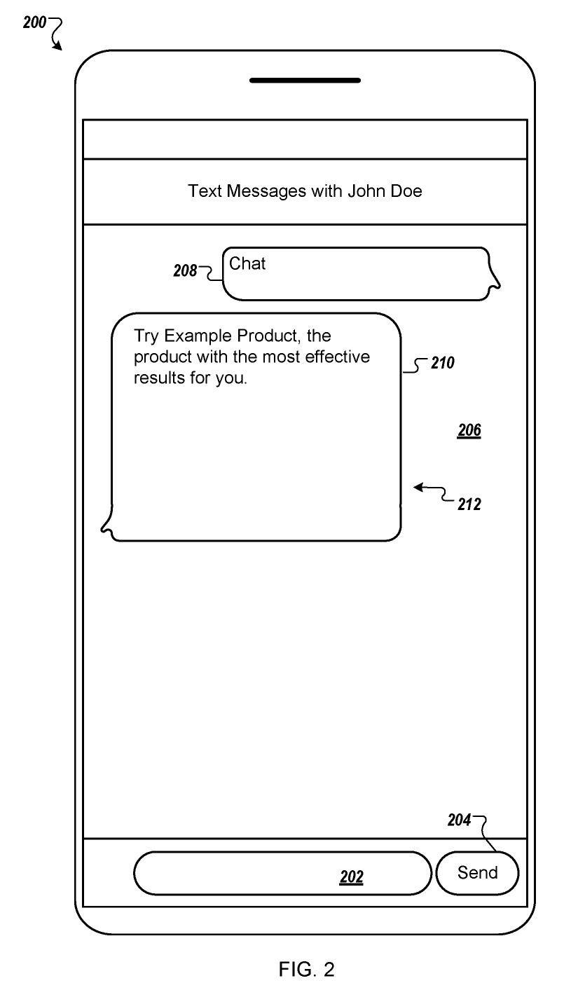

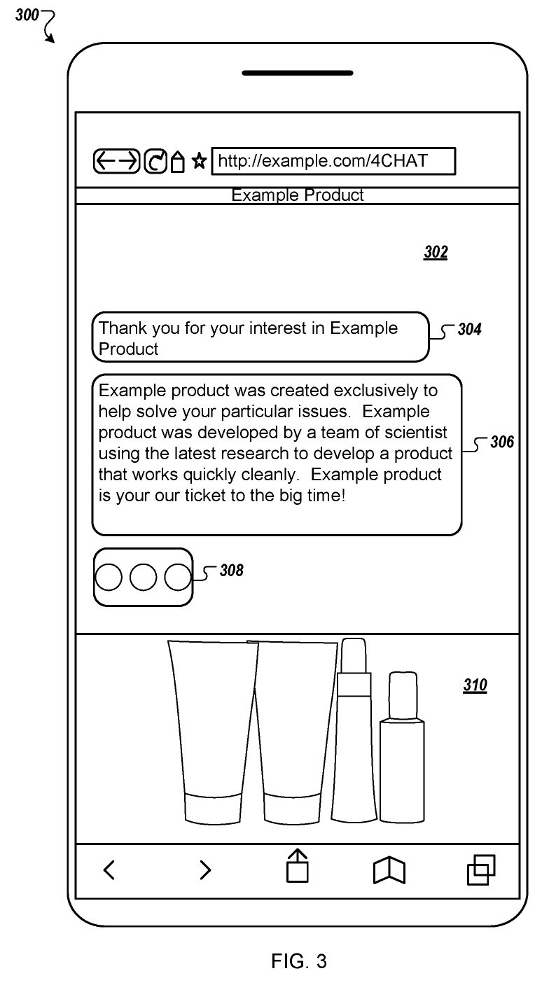

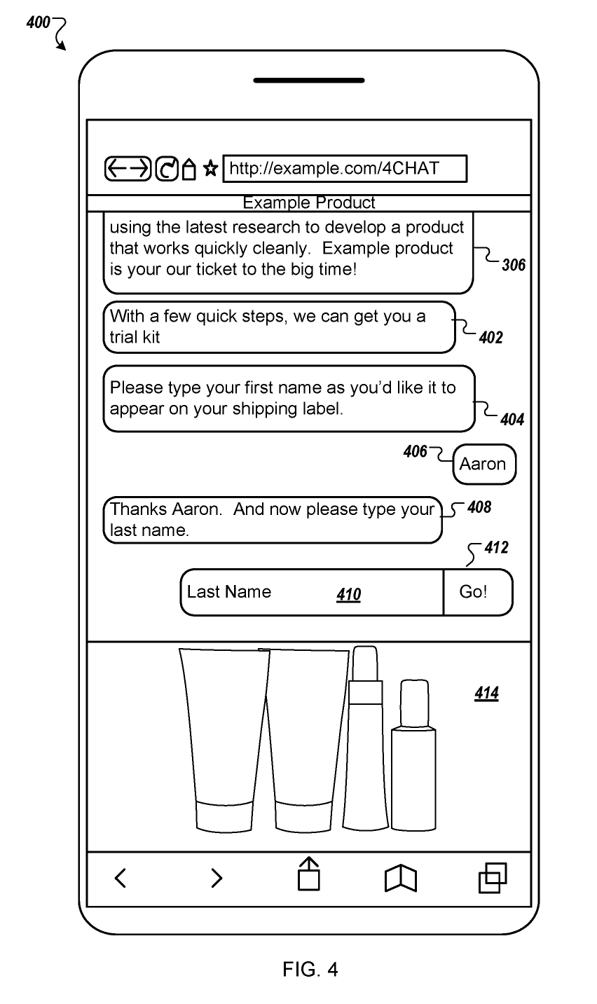

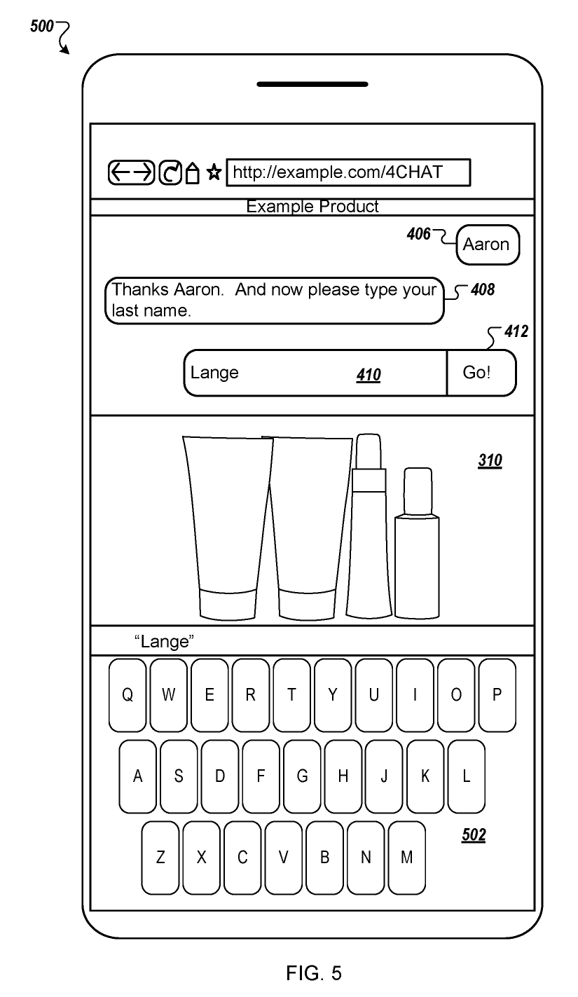

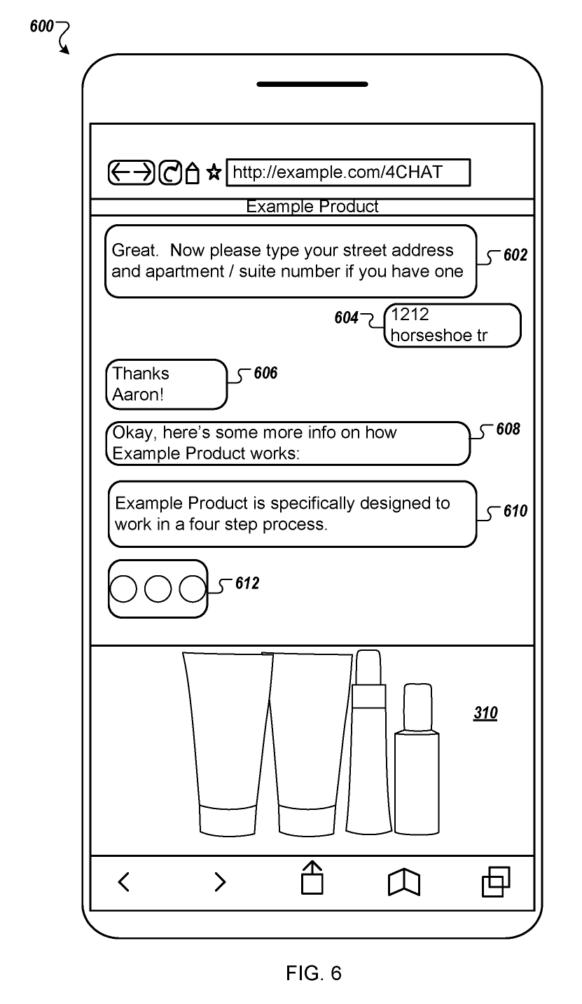

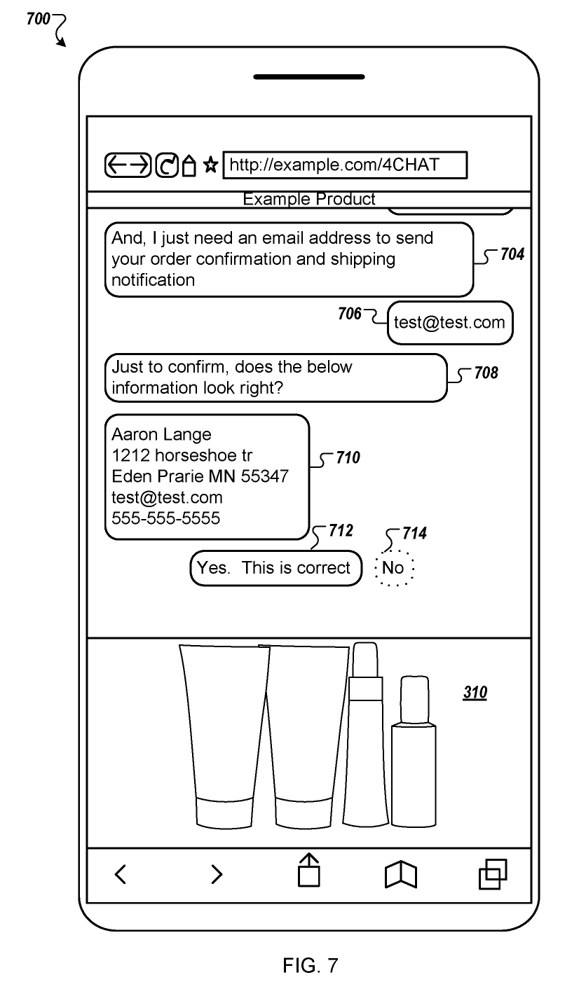

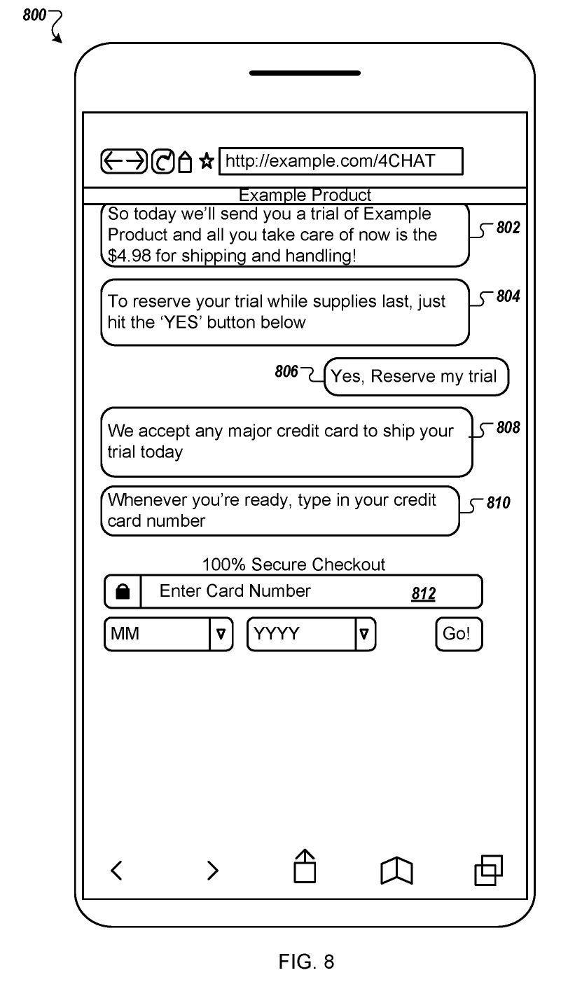

FIG. 2 is a user interface 200 of a phone showing a SMS conversation. FIGS. 3-8 are user interfaces 300-800 of a phone showing a webpage based conversation. These user interfaces 200-800 may be used, for example, in the system 100 and displayed on the phone 102. However, the user interfaces could also be used by other appropriate computing devices including tablets, laptops, desktop computers, kiosk stations, video game consoles, etc. In order to advantageously provide a user interface on a wide array of devices, the interfaces may be generated as adaptive interfaces that can scale and stretch dynamically depending on the available device.

The user interface 200 shows a SMS program of a phone. The particular look and feel of the user interface 200 may be dictated by, for example, the SMS application and the operating system of the phone. For example, the colors, layout, and interface elements may be set by the developers of the phone and/or user configuration. The SMS program generally can allow a user to send and receive SMS messages, optionally along with other chat messages. When a user enters text in an input box 202 and presses a button 204, the SMS program can send an SMS containing the entered text. In this example, the recipient address (e.g., phone number of short code) has already been entered, but some other SMS application allow for entry of the recipient address in the same user interface.

A chat log area 206 can show the messages of the chat. In this example, the SMS application shows the messages in a dynamically updating reverse chronology. That is to say, new messages are shown below older messages, and the messages are added as they come in without any need to initiate a refresh by the user.

In this example, the user has sent a message 208 “Chat” to a particular address that is operating a chat server configured to automatically reply. The chat server has responded with a message 210. As shown, the message 210 includes a link 212 to “http://example.com/4Chat.” If the user taps on the displayed link 212, the phone can load a web browser and request the document published at the address “http://example./com/4Chat.”

The user interface 300 shows a new user interface displayed on the phone after the user has clicked on the link 212. This user interface 300 is created by a phone's web browser application, which in some cases may be an element of the SMS application and in some cases be a separate application. The webpage in the user interface 300 includes a chat interface 302 that shows messages 304 and 306 in a dynamically updating reverse chronology. Additionally, a working bubble 308 is shown to let the user know that additional messages are incoming.

Unlike in the SMS program, where the input box 202 and button 204 are shown at all time in an area sometimes called the “chrome” of the application, the user interface 202 is able to not render an input box and button because there is not yet an input requested from the user.

The user interface 300 also includes a display area 310 that renders an image associated with the chat being shown in the user interface 300. In this example, a product is being discussed in the chat, and an image of the product is displayed in the display area 310.

In general, the interface 300 has been configured to support a chat experience. In this example, the look and feel of the interface 300 is different than the look and feel of the interface 200. That is, the color schemes, fonts, and layout are slightly different. This may be advantageous in some situations to signal to the user that, while they are participating in a chat experience, they are doing so outside of the context of their SMS application and in the context of a web browser or other application. In other configurations, the webpage can be configured to have a look and feel that matches the SMS application. This may be desirable, for example, to provide the user with a more seamless aesthetic experience.

The user interface 400 shows the webpage at a later moment in time than the user interface 300. As can be seen, the message 306 has moved upward to allow for the display of newer messages 402-408. The messages 306 and 402-408 can be displayed according to conventions that are common in chat applications. For example, the messages 306, 402, 505, and 408 from a chat server are shown in one color (i.e. gray) with left justification while the message 406 from the user of the phone is shown in a different color (i.e., green) with right justification.

The user interface 400 shows an input box 410 and button 412. In this example, the script running the chat on the chat server calls for input from a user—specifically for the user to provide their last name. In order to allow the user to provide their last name, the user interface 400 renders the input box 410 into which the user may type. Once the user has finished typing their last name, pressing the button 412 can submit the data entered into the input box 410. The user interface 500 shows a keyboard 502 used to enter the last name “Lange” into the input box 410.

The user interface 600 shows the webpage at a later moment in time than the user interface 500. As can be seen, messages 602-610 and a working bubble 612 have been displayed.

The user interface 700 shows the webpage at a later moment in time than the user interface 600. As can be seen, messages 704-710 have been displayed. User inputs that are not normally available in many chat programs have also been made available. Buttons 712 and 714 have been rendered, allowing the user to indicate if the information provided is correct or not by pressing button 712 or 714, respectively.

The user interface 800 shows the webpage at a later moment in time than the user interface 700. As can be seen, messages 802-810 have been displayed. An input box 812 and drop down menus 814 and 816 have been provided to allow a user to enter credit card information over a secure connection. Unlike a freeform text input, the input box 812 and drop down menus 814 and 816 can be limited to allow only valid input (e.g., credit card numbers and date numbers). Unlike some chat protocols (e.g., SMS) which allow any typed text to be submitted, use of a webpage for data submission may allow for input that is limited only to valid input, as is shown here. A button 818 allows for the submission of the data entered in the input box 812 and drop down menus 814 and 816.

Unlike some chat protocols (e.g., SMS), the use of a webpage for data submission may allow for secure submission over an encrypted connection such as Hypertext Transfer Protocol Secure (HTTPS). By transitioning a chat experience from SMS to HTTPS, data security is enhanced. Use of a securely encrypted connection prevents third parties from observing the contents of a submission. This can increase the trust a user places in the chat experience, even if they initiate the chat experience over an unsecured format. In other examples, other inputs not normally available in many chat programs may be available. For example, radio buttons, obfuscated password fields, or other input elements may be available. Additionally, or alternatively, non-text based input may be submitted. For example, the webpage may ask a user to permit the webpage to access the user's camera on their device. The camera input can be submitted to the chat server, which may apply computer vision, artificial intelligence, or other techniques to analyze the image or video captured. In some cases, the camera may capture images of the user, which may be used to identify information about the user such as age, gender, or emotional state. These signals can be used to guide a user through the chat. For example, a chat allowing a user to purchase personal hygiene products may guide a user toward different product lines based on age and gender.

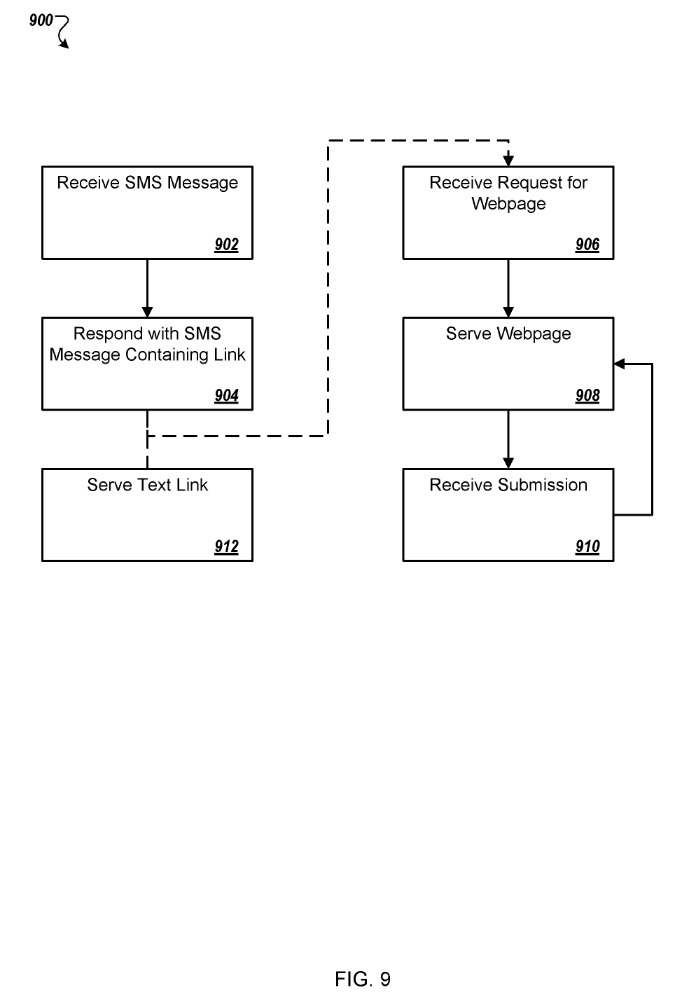

FIG. 9 is a flowchart of an example process 900 for communicating over SMS and webpage. The process 900 may be performed, for example, by elements of the system 100. Therefore, the following example will be described using the system 100. However, other systems or groups of systems may be used to perform the process 900 or a similar process.

An SMS message is received 902. For example, the user 104 may be shopping at a local grocery store and see a sign calling her to text “Loyalty” to a particular short code address in order to sign up for a customer loyalty program. Wishing to enroll in the program, the customer can bring up her SMS chat application to draft and send an SMS message 106 containing the word “Loyalty” to the provided short code. The SMS message 106 may be sent from the user's 104 phone 102, pass through the phone's 102 cellular network, and arrive at the chat server 108.

An SMS response is sent 904. For example, the chat server 108 can parse the contents of the SMS message 106 to identify that it contains the text “Loyalty.” The chat server 108 may then draft or access a stored SMS response 110 that contains a link to a webpage that continues the user's 104 chat experience to sign up for the loyalty program. In some cases, the chat server 108 can service many different types of SMS messages, and may look up an SMS response 110 from a table of possible SMS responses based on, for example, the contents of the SMS message 106.

A request for a webpage is received 906. For example, the phone 102 can render the SMS reply 110 to the user such that the link becomes a clickable link. The user 104 can click on the rendered link, causing the phone 102 to send an HTTPS request to the address of the link. This HTTPS can pass from the phone 102, through a data network such as the Internet, to the chat server 108 where it is received.

A webpage is served 908. For example, the chat server 108 can serve the webpage associated with the address. This webpage may be configured to continue the chat experience with the customer by, for example, providing elements common to chat experiences such as a rolling log of messages and input elements for sending new messages.

A submission is received 910. For example, the webpage may include instructions to render input elements on the phone 102. The user 104 can enter information requested (e.g., name, address, loyalty program level) for submission. The chat server can receive this submitted information, and update service 908 of the webpage to continue the chat experience through completion of registration of the loyalty program.

In some cases, serving the webpage 908 and 910 can include selecting one script to use out of a plurality of possible scripts. For example, an advertiser can create two scripts in order to perform an AB test to determine which script is more effective. When the webpage is served 908, one of the two scripts may be selected, and received submissions 910 may be examined in order to determine an efficacy score for that script.

With efficacy scores calculated for all possible scripts, the system may begin serving more successful scripts more often. For example, if Script A is shown to convert a sale in 30% of sessions and Script B is shown to convert a sale in 40% of sessions, the system may begin using Script B exclusively.

Variations of the process 900 are possible. For example, a dotted line is used to connect 904 to 906. This is because 902-904 and 906-910 may optinally be performed by separate process or separate servers. For example, one process (e.g., a group of virtual machines) hosted by a cloud-hosting service may be responsible for handling SMS messages in 902-904, while another process (e.g., another group of virtual machines) hosted by the same or a different cloud-hosting service may be responsible for handling we traffic in 906-910. These different processes may or may not communicate with each other in different configurations. Other variations are possible.

While chats have been mostly described as a text-based exchange, it is possible for other types of chat to be used. In some cases, instead of an SMS exchange being transitioned to a webpage chat, it is possible to instead use an audio exchange that is transitioned to a webpage chat. For example, a user may initiate a chat with their voice-based home automation or personal assistant device (e.g., by saying a special key word) and asking this device to send a particular message to a particular address or destination. In response, the chat server can send the chat reply back to the device and transition to the webpage based chat.

In another alternative, a user may click on a text-link or graphical advertisement to enter the web-based chat experience. For example, an advertiser may generate a chat script, set up the chat environment, etc., and may provide more than one way to transition to receiving a request for the webpage 906. For example, a text link can be served 912. In such an example, a text based or graphical ad may be served as part of a webpage (e.g., search result page, social media page) or application (e.g., music application, video game, streaming video application). A user may click or select the advertisement or the text link, and be transitioned to requesting the webpage 906. This may advantageously enable, for example, a single chat experience to be reachable from multiple different ingress points, sometimes called funnels.

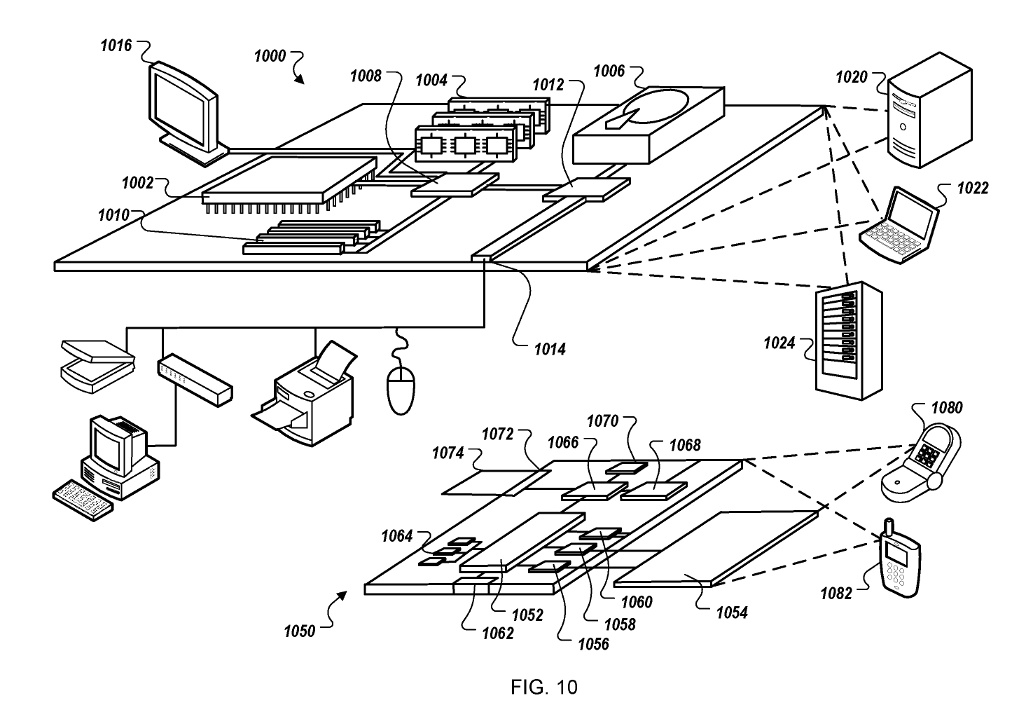

FIG. 10 shows an example of a computing device 1000 and an example of a mobile computing device that can be used to implement the techniques described here. The computing device 1000 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1000 includes a processor 1002, a memory 1004, a storage device 1006, a high-speed interface 1008 connecting to the memory 1004 and multiple high-speed expansion ports 1010, and a low-speed interface 1012 connecting to a low-speed expansion port 1014 and the storage device 1006. Each of the processor 1002, the memory 1004, the storage device 1006, the high-speed interface 1008, the high-speed expansion ports 1010, and the low-speed interface 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as a display 1016 coupled to the high-speed interface 1008. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1004 stores information within the computing device 1000. In some implementations, the memory 1004 is a volatile memory unit or units. In some implementations, the memory 1004 is a non-volatile memory unit or units. The memory 1004 may also be another form of computer-readable medium, such as a magnetic or optical disk.

The storage device 1006 is capable of providing mass storage for the computing device 1000. In some implementations, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The computer program product can also be tangibly embodied in a computer- or machine-readable medium, such as the memory 1004, the storage device 1006, or memory on the processor 1002.

The high-speed interface 1008 manages bandwidth-intensive operations for the computing device 1000, while the low-speed interface 1012 manages lower bandwidth-intensive operations. Such allocation of functions is exemplary only. In some implementations, the high-speed interface 1008 is coupled to the memory 1004, the display 1016 (e.g., through a graphics processor or accelerator), and to the high-speed expansion ports 1010, which may accept various expansion cards (not shown). In the implementation, the low-speed interface 1012 is coupled to the storage device 1006 and the low-speed expansion port 1014. The low-speed expansion port 1014, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. In addition, it may be implemented in a personal computer such as a laptop computer 1022. It may also be implemented as part of a rack server system 1024. Alternatively, components from the computing device 1000 may be combined with other components in a mobile device (not shown), such as a mobile computing device 1050. Each of such devices may contain one or more of the computing device 1000 and the mobile computing device 1050, and an entire system may be made up of multiple computing devices communicating with each other.

The mobile computing device 1050 includes a processor 1052, a memory 1064, an input/output device such as a display 1054, a communication interface 1066, and a transceiver 1068, among other components. The mobile computing device 1050 may also be provided with a storage device, such as a micro-drive or other device, to provide additional storage. Each of the processor 1052, the memory 1064, the display 1054, the communication interface 1066, and the transceiver 1068, are interconnected using various buses, and several of the components may be mounted on a common motherboard or in other manners as appropriate.

The processor 1052 can execute instructions within the mobile computing device 1050, including instructions stored in the memory 1064. The processor 1052 may be implemented as a chipset of chips that include separate and multiple analog and digital processors. The processor 1052 may provide, for example, for coordination of the other components of the mobile computing device 1050, such as control of user interfaces, applications run by the mobile computing device 1050, and wireless communication by the mobile computing device 1050.

The processor 1052 may communicate with a user through a control interface 1058 and a display interface 1056 coupled to the display 1054. The display 1054 may be, for example, a TFT (Thin-Film-Transistor Liquid Crystal Display) display or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may provide communication with the processor 1052, so as to enable near area communication of the mobile computing device 1050 with other devices. The external interface 1062 may provide, for example, for wired communication in some implementations, or for wireless communication in other implementations, and multiple interfaces may also be used.

The memory 1064 stores information within the mobile computing device 1050. The memory 1064 can be implemented as one or more of a computer-readable medium or media, a volatile memory unit or units, or a non-volatile memory unit or units. An expansion memory 1074 may also be provided and connected to the mobile computing device 1050 through an expansion interface 1072, which may include, for example, a SIMM (Single In Line Memory Module) card interface. The expansion memory 1074 may provide extra storage space for the mobile computing device 1050, or may also store applications or other information for the mobile computing device 1050. Specifically, the expansion memory 1074 may include instructions to carry out or supplement the processes described above, and may include secure information also. Thus, for example, the expansion memory 1074 may be provided as a security module for the mobile computing device 1050, and may be programmed with instructions that permit secure use of the mobile computing device 1050. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1064, the expansion memory 1074, or memory on the processor 1052. In some implementations, the computer program product can be received in a propagated signal, for example, over the transceiver 1068 or the external interface 1062.

The mobile computing device 1050 may communicate wirelessly through the communication interface 1066, which may include digital signal processing circuitry where necessary. The communication interface 1066 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1068 using a radio-frequency. In addition, short-range communication may occur, such as using a Bluetooth, WiFi, or other such transceiver (not shown). In addition, a GPS (Global Positioning System) receiver module 1070 may provide additional navigation- and location-related wireless data to the mobile computing device 1050, which may be used as appropriate by applications running on the mobile computing device 1050.

The mobile computing device 1050 may also communicate audibly using an audio codec 1060, which may receive spoken information from a user and convert it to usable digital information. The audio codec 1060 may likewise generate audible sound for a user, such as through a speaker, e.g., in a handset of the mobile computing device 1050. Such sound may include sound from voice telephone calls, may include recorded sound (e.g., voice messages, music files, etc.) and may also include sound generated by applications operating on the mobile computing device 1050.

The mobile computing device 1050 may be implemented in a number of different forms, as shown in the figure. For example, it may be implemented as a cellular telephone 1080. It may also be implemented as part of a smart-phone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

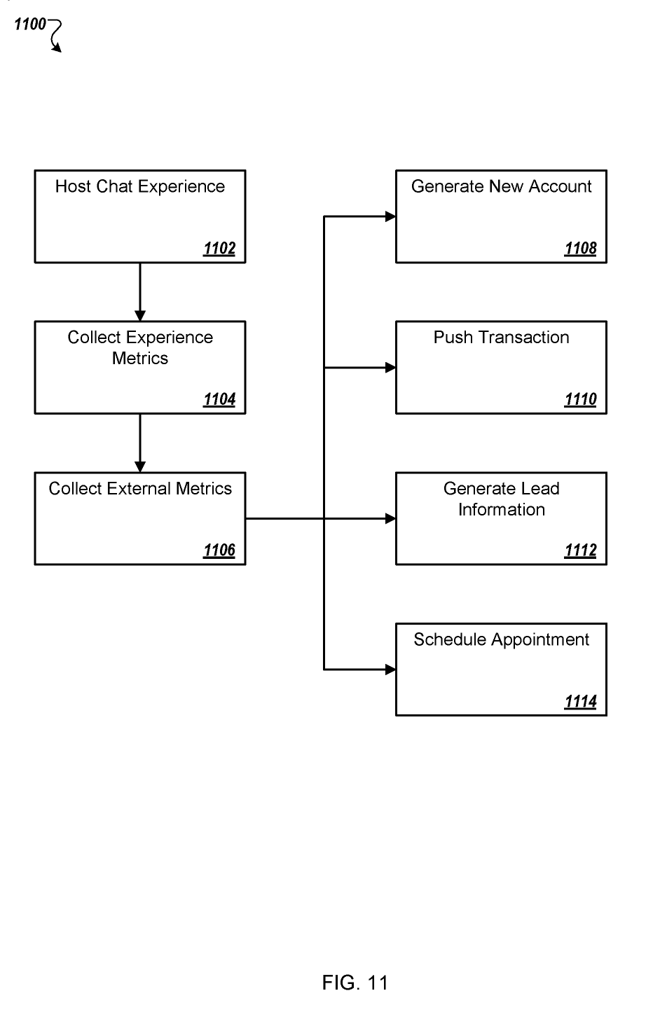

FIG. 11 is a flowchart of an example process for serving a webpage that provides a chat interface. The process 900 may be performed, for example, as part of serving the webpage 908 and receiving submissions 910. As is shown below, the chat interface can be used to generate one or more external interactions. Shown here are four possible external interactions—generating a new account 1108, transmitting a transaction 1110, generating lead information 1112, and scheduling an appointment 1114. However, other external interactions are possible, and more, fewer, and a different number of external interactions can be used in various implementations.

A chat webpage is served 1102. For example, a user can transition to a chat webpage from another channel such as a text message, website-based text link, etc. Then, the user can be provided with a graphical chat interface that follows a script to provide the user with a series of questions or other chat interactions in order to allow the user to submit information in a comfortable and familiar environment.

Experience metrics are collected 1104. For example, while the webpage is being interacted with by the user, the user's experience can be measured and recorded. These measurements can include information about how the user has interacted with the chat. For example, the delay between the display of a question and the submission of a response by the user may be measured. If a user decides to terminate a chat session, the location in the script and the time from the beginning of the chat can be measured. Semantic analysis may be performed to identify, for example, a positive communication (e.g., “I love this phone, but something isn't working right!”) versus a negative communication (e.g., “This stupid phone doesn't work right!”). Demographic information can be collected, either directly or indirectly. That is, a user may be asked about their demographic information to directly collect demographic information. Additionally or alternatively, demographic data may be understood based on other data such as a geolocation look up of the user's device.

External data is collected 1106. For example, information about the user or the user's situation can be collected from one or more data sources that are external to the system. One example of such a system is a demographics service that is able to report demographic information for a given person, a given zip code, etc. One such example of such a system is a shipping confirmation system that is able to confirm address information. For example, if a user enters a city and zip code in their address, the shipping confirmation system may be queried to ensure that the user's city and zip code match.

With this information, one or more external interactions may be initiated. In some cases, a particular system can be configured to only perform one particular external interaction or a defined set of external interactions. In some cases, different scripts may call for different external interactions, possibly depending on the selection made by the user.

A new account is generated 1108. For example, the system can generate a new user account for the chat system and/or an external system. For the chat system, the script of the chat can ask the user for their information needed for the account (e.g., email, password, payment method, security questions), and then use that collected information to directly generate an account for the user. Additionally or alternatively, the system may also communicate with an external system in order to create a user account for the user in the external system.

For example, a vendor may wish to sign up with the system to be an advertiser. The chat web site may ask the vendor information about their product and service, and may collect information about the vendor. Then, the system may setup an account for the vendor within the system, begin the process of generating one or more scripts for the vendor, etc. With this account, the vendor can begin to act as an advertiser for their products and services, providing advertisements that begin with a text message and transition to a website based chat system.

At the same time, the system may also open one or more external accounts for the vendor, if asked to do so by the vendor. For example, in order to allow the vendor to begin taking online orders, the system may open an account for the vendor with a payment processor and/or online marketplace service. The system can communicate with the external service, for example through an API or other communication interface. Once the account is created, the system can provide the account details to the vendor, who may then begin using the account with the external service.

In another example, the chat website may be served to a potential new customer of an existing advertiser. For example, a user may be interested in becoming a customer of an advertiser that sells weekly groceries and matching recipes. The chat may ask the user for their dietary preferences and restrictions, and then ask the user for information needed to set up an account with the advertiser. Once this information is collected, the system can create an account with the vendor for the user, so that the user will begin to receive their weekly shipments and can, in the future, log into the advertiser's website directly.

A transaction is transmitted 1110. For example, the chat webpage can be used to complete a purchase or other transaction with the user. A product may be sold, a shipment may be arranged, etc. In order to collect information for the transaction, the chat webpage can ask questions according to a script, and the user answers may be used to perform the transaction (e.g., process payment, schedule a shipment).

Lead information is generated 1112. For example, the experience metrics and/or the collected external data can be collected into information useful for a sales lead. This may include, for example, demographic information, an interest value calculated from how the user interacted with the chat interface, etc. The user may be assigned a priority value that represents an estimation of their priority as a sales lead. A high priority may be calculated for a user that is within the target demographic, for a user that has showed a high level of interest, etc. The lead information for this user may be added to similar lead information related to other users and transmitted to an external system for use in follow-up sales effort. For example, the lead information can be sent to a sales management server, and the sales management server may assign follow-up tasks to sales personnel based on the priority value of each user.

An appointment is scheduled 1114. For example, many products and services use an appointment with the user, and the appointment can be created by the system based on the user's input in the chat experience. For example, an advertiser may offer a service involving one-on-one communication between a customer and the advertiser (e.g., an interior designer to visit the customer's home for a consult, a medical provider making appointments for patients, an interested customer asking for a call-back from a salesperson).

In order to facilitate this appointment scheduling, the system may access data stored on an external server that specifies availability of personnel associated with the advertiser. For example, an advertiser may have four insurance agents available for telephone consults with interested customers. The system may access and API the reports time slots at which each of those four agents are currently available. The chat system may then provide to the user the ability to schedule a call with one of the insurance agents, but only at times at least one agent is available.

What is claimed is:

1. A system comprising:
a user device configured to:
receive user input specifying contents of a chat message;
send, to a chat server, a text message that has been generated based on the user input specifying contents of a chat message;
receive, after sending the text message, a text response containing a link to a webpage;
receive user input selecting the link to the website;
send, to the chat server, a request for the website;
receive, after sending the request for the website, the website;
display the website;
receive, from the user, chat input to the website displayed; and
submit, to the chat server, the chat input; and
the chat server configured to
receive, from the user device, the text message;
send, responsive to receiving the text message, the text response to the user device;
receive, from the user device; the request for the website;
send, to the user device, the website; and
receive, after sending the website to the user device, the submitted chat input.

2. The system of claim 1, wherein the text message is one of the group consisting of Short Message Service (SMS) and Search Results Multimedia Messaging Service (MIMS) message); and
wherein the text message is sent from a short code number.

3. The system of claim 1, wherein the website is configured to be rendered on the user device, and wherein the website, when rendered provides the user with a chat experience that includes providing the user with text communications and provides the user with input elements to receive the submitted chat input.

4. The system of claim 3, wherein the script defines a decision tree that, when used by the rendered webpage, provides text communication defendant upon the received chat input.

5. The system of claim 1, wherein the chat server is further configured to:
receive, from a second user device, a second request for the website, the request from the second user device being generated based on a link rendered in a different website.

6. The system of claim 1, wherein the chat server is further configured to:
generate a new account in an external service for a user of the user device based on the chat input.

7. The system of claim 1, wherein the chat server is further configured to:
schedule an appointment for a user of the user device based on the chat input.

8. The system of claim 1, wherein the chat server is further configured to:
transmit a transaction record to an external service based on the chat input.

9. The system of claim 1, wherein the chat server is further configured to:
collect experience metrics based on the chat input;
collect external data from an external system based on the chat input;
calculate, for a user of the user device, a priority value; and
transmit, to a second external system, the priority value.

10. The system of claim 9, wherein the priority value is a sale-lead priority value.

11. A method comprising:
receiving, from a user device, a text message;
send, responsive to receiving the text message, a text response to the user device, the text response containing a link to a webpage;
receive, from the user device; a request for the website;
send, to the user device, the website; and
receive, after sending the website to the user device, submitted chat input from the user device.

12. The method of claim 11, wherein the text message is one of the group consisting of Short Message Service (SMS) and Search Results Multimedia Messaging Service (MIMS) message); and
wherein the text message is sent from a short code number.

13. The method of claim 11, the website is configured to be rendered on the user device, and wherein the website, when rendered provides the user with a chat experience that includes providing the user with text communications and provides the user with input elements to receive the submitted chat input.

14. The method of claim 13, wherein the script defines a decision tree that, when used by the rendered webpage, provides text communication defendant upon the received chat input.

15. The method of claim 11, the method further comprising receiving from a second user device, a second request for the website, the request from the second user device being generated based on a link rendered in a different website.

16. The method of claim 11, the method further comprising generating a new account in an external service for a user of the user device based on the chat input

17. The method of claim 11, the method further comprising scheduling an appointment for a user of the user device based on the chat input.

18. The method of claim 11, the method further comprising transmitting a transaction record to an external service based on the chat input.

19. The method of claim 11, the method further comprising:
collecting experience metrics based on the chat input;
collecting external data from an external system based on the chat input;
calculating, for a user of the user device, a priority value; and
transmitting, to a second external system, the priority value.

20. The method of claim 19, wherein the priority value is a sale-lead priority value.
